(19) United States
(12) Patent Application Publication
(10) Pub. No.: US 2009/0046211 A1
(43) Pub. Date: Feb. 19, 2009

(54) IMAGE DISPLAY DEVICE AND CONTROL METHOD THEREOF

(75) Inventors: Koji Maekawa, Kanagawa (JP); Eimei Nanma, Kanagawa (JP); Kaori Mori, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 12/281,592

(22) PCT Filed: Apr. 20, 2007
(86) PCT No.: PCT/JP2007/058668

§ 371 Date: Sep. 3, 2008

(30) Foreign Application Priority Data
Apr. 20, 2006 (JP) 2006-116791

(51) Int. Cl. H04N 5/66

(52) U.S. Cl. 348/739; 348/E05.133

(57) ABSTRACT

An object of the invention is to provide an image display device and a control method thereof which can reduce an image retrieving time and suppress an amount of data to be transmitted for retrieval.

An image display device (4) is connected via communication lines to an NW cameral (1) for delivering picked-up images and a recorder (3) for storing the delivered images and displays the delivered images on an image display portion (43). The image display device (4) includes a data communication portion (41) for receiving image data from the NW camera 1, an image display control portion (42) for decoding the image data thus received and subjecting the decoded data to an image processing to thereby output to the image display portion (43), a thumbnail managing portion (44) for determining whether or not the received image data satisfies a predetermined condition as a subject to be displayed as a thumbnail, and a thumbnail storage portion (45) for storing only image data which is determined to satisfy the condition by the thumbnail managing portion (44).

### TECHNICAL FIELD

The present invention relates to an image display device which is connected via communication lines to an image delivery device for delivering images and an image storage device for storing the delivered images and displays the delivered images on a display portion, and a control method thereof.

### BACKGROUND ART

There is provided a system in which a receiving side located at a remote place retrieves many still images stored in a storage device on a transmitting side and receives the retrieved images, wherein firstly, reduced image data and explanatory character information are transmitted to the receiving side, then the receiving side displays the reduced image data and the explanatory character information thus transmitted and selects a required image, and the selected result is transmitted to the transmitting side as an image transmission request (see a patent document 1, for example). Thus, since the required still image can be selected only by the transmission of the reduced image data etc. having s small information amount, it is sufficient to transmit only the selected image data in accordance with the selection, so that the efficiencies of retrieval and transmission can be improved.

### [Patent Document 1] JP-A-7-219967

### DISCLOSURE OF THE INVENTION

### Problems that the Invention is to Solve

However, in the aforesaid system, since it is necessary to transmit the reduced images for retrieval from the transmitting side at the time of retrieving images on the receiving side, the retrieval time becomes longer by a time corresponding to the transmission. Further, since the transmission side is also required to transmit the reduced images other than an image actually selected by the receiving side, an amount of data to be transmitted increases.

The invention is made in view of the aforesaid circumstance and an object of the invention is to provide an image display device and a control method thereof which can reduce an image retrieving time and suppress an amount of data to be transmitted for retrieval.

### Means for Solving the Problems

The image display device according to the invention is an image display device which is connected via a communication line to an image delivery device for delivering images and an image storage device for storing the delivered images and displays the delivered images on a display portion, inducing:

a data communication portion which receives image data from the image delivery device;

an image display control portion which decodes the image data thus received at the data communication portion and subjects the decoded data to an image processing to thereby output to the image display portion;

a reduced image managing portion which determines whether or not the image data received at the data communication portion satisfies a predetermined condition as a subject to be displayed as a reduced image; and

an which stores only image data that is determined to satisfy the condition by the reduced image managing portion.

According to this configuration, in the image display device, since only image data as a subject to be displayed as a reduced image is stored, it is possible to eliminate a procedure of obtaining reduced image data for retrieval from the image storage device side at the time of retrieving an image. Thus, a retrieval time can be shortened and an amount of data communication between the image display device and the image storage device can be suppressed.

Further, in the image display device according to the invention, the reduced image managing portion reads, when an displaying a reduced image is input, image data from the image data storage portion and outputs the image data thus read to the image display control portion, and the image display control portion decodes the image date obtained from the reduced image managing portion to prepare a reduced image.

According to this configuration, since the image data storage portion can store coded data with respect to image data as a subject to be displayed as a reduced image, an amount of stored data can be reduced.

Further, in the image display device according to the invention, the image display control portion decodes image data which is determined to satisfy the condition as a subject to be displayed as a reduced image by the reduced image managing portion to prepare a reduced image and stores the reduced image in the image data storage portion.

According to this configuration, since the image data storage portion stores reduced images thus prepared, the reduced image can be displayed quickly by reading the reduced image thus stored at the time of displaying the reduced image.

Further, the image display device according to the invention further includes an image data request portion which requests, when an instruction of selecting a reduced image displayed on the display portion is input, the image storage device as to image data relating to the reduced image thus selected.

According to this configuration, since the image storage portion is requested as to the image data relating to the reduced image thus selected, the image storage portion is required to transmit only image data required on the image display device side and so a data amount transmitted from the image storage device can be suppressed.

Further, in the image display device according to the invention, the data communication portion stops its operation while the display portion is not operated, and the image data request portion requests, when an operation of the display portion is restarted, the image storage portion as to image data satisfying the condition as a subject to be displayed as a reduced image.

According to this configuration, since the image reception operation is stopped while the display portion is not operated, an amount of dissipation power can be reduced. Further, since the image data as a subject to be displayed as reduced images is requested to the image storage device after the restart of the operation, image data to be stored can be secured.

An image delivering system according to the invention includes:

the image display device;

an image delivering device which is connected to the image display device via a communication line and delivers image data; and

an image storage device which stores images delivered from the image delivering device.

According to this configuration, in the image display device, since only image data as a subject to be displayed as a reduced image is stored, it is possible to eliminate a procedure of obtaining reduced image data for retrieval from the image storage device side at the time of retrieving an image. Thus, a retrieval time can be shortened and an amount of data communication between the image display device and the image storage device can be suppressed. Further, since the image storage device is not required to prepare reduced images, the image storage device is not required to contain a decoder and so the configuration thereof can be simplified.

Further, in the image delivering system according to the invention, the image delivering device is a camera device which has an image pickup portion for picking up an image and delivers image data thus picked-up to the image display device and the image storage device.

According to this configuration, in a system of delivering images from a so-called network camera such as a surveillance camera, in the case of retrieving images having been picked-up in the past, it is possible to retrieve a reduced image on the image display device side.

A method of controlling an image display device according to the invention is a method of controlling the image display device which is connected via a communication line to an image delivery device for delivering images and an image storage device for storing the delivered images and displays the delivered images on a display portion, including:

a step of receiving image data from the image delivery device;

a step of decoding the image data thus received and subjecting the decoded data to an image processing to thereby output to the image display portion;

a step of determining whether or not the received image data satisfies a predetermined condition as a subject to be displayed as a reduced image; and

a step of storing only image data that is determined to satisfy the condition into an image storage portion.

According to this method, in the image display device, since only image data as a subject to be displayed as a reduced image is stored, it is possible to eliminate a procedure of obtaining reduced image data for retrieval from the image storage device side at the time of retrieving an image. Thus, a retrieval time can be shortened and an amount of data communication between the image display device and the image storage device can be suppressed.

The invention provides a program for executing by a computer the respective steps of the method of controlling the image display device.

According to this program, in the image display device, since only image data as a subject to be displayed as a reduced image is stored, it is possible to eliminate a procedure of obtaining reduced image data for retrieval from the image storage device side at the time of retrieving an image. Thus, a retrieval time can be shortened and an amount of data communication between the image display device and the image storage device can be suppressed.

### EFFECTS OF THE INVENTION

According to the invention, it is possible to provide an image display device and a control method thereof which can reduce an image retrieving time and suppress an amount of data to be transmitted for retrieval.

### BRIEF DESCRIPTION OF THE DRAWINGS

FIG. 1 is a block diagram showing the schematic configuration of an image delivering system according an embodiment of the invention.

FIG. 2 is an explanatory diagram showing a flow of image data in the image delivering system according to the embodiment of the invention.

FIG. 3 is a flowchart for explaining a method of storing image data for thumbnails in the image display device according to the embodiment of the invention.

FIG. 4 is a flowchart for explaining the image data retrieving method of the image display device according to the embodiment of the invention.

FIG. 5 is a sequential chart for explaining a method of storing image data for thumbnails in the image display device according to the embodiment of the invention.

### EXPLANATION OF SYMBOLS

1 network
2 switch
3 recorder
4 image display device
41 data communication portion
42 image display control portion
43 image display portion
44 thumbnail managing portion
45 thumbnail storage portion
46 image data request portion
47 input portion

### BEST MODE FOR CARRYING OUT THE INVENTION

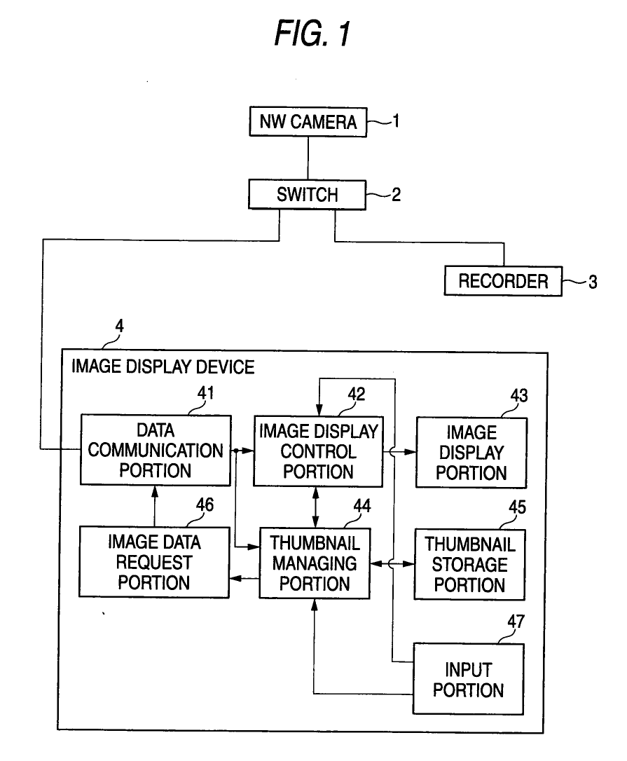

FIG. 1 is a block diagram showing the schematic configuration of an image delivering system according an embodiment of the invention. As shown in FIG. 1, the image delivering system according the embodiment includes a network camera (hereinafter called an NW camera) 1, a switch 2, a recorder 3 and an image display device 4, which are connected via a communication lines such as a LAN (Local Area Network).

The cameral 1 operates as an example of an image delivering device for delivering images and includes an image pickup portion for picking-up image data, whereby the camera encodes the image data thus picked-up, then superimposes additional information thereon and delivers the image to a designated destination via the communication line. The additional information superimposed on the image data may be time information, a characteristic amount of the image representing change etc. of the image, event information such as alarm generation information from a sensor in the case where the sensor is provided at the NW camera, for example.

The switch 2 switches a transmission path in accordance with the destination of the image data output from the NW camera 1. The recorder 3 operates as an example of an image storage device and stores the image data delivered from the NW camera 1. Further, the recorder 3 transmits the image data stored therein to the image display device 4 in accordance with a request from the image display device 4.

The image display device 4 includes a data communication portion 41, an image display control portion 42, an image display portion 43, a thumbnail managing portion 44, a thumbnail storage portion 45, an image data request portion 46 and an input portion 47.

The data communication portion 41 is connected to the communication line and receives the image data transmitted from the NW camera 1. Further, the data communication portion receives the image data transmitted from the recorder 3 and transmits an image data request to the recorder 3.

The image display control portion 42 decodes the image date received by the data communication portion 41, then subjects the decoded image data to an image processing and outputs the processed image to the image display portion 43. The image display portion 43 displays the image output from the image display control portion 42.

The thumbnail managing portion 44 operates as an example of a reduced image managing portion in a manner of determining whether or not the received image data satisfies a condition as a subject to be displayed as a predetermined reduced image (hereinafter called a thumbnail) and stores in the thumbnail storage portion 45 only the image data which is determined to satisfy the condition. The thumbnail managing portion 44 is configured mainly by a processor which operates in accordance with a predetermined program.

The thumbnail storage portion 45 operates as an example of an image data storage portion and stores image data to be displayed as a thumbnail which is written by the thumbnail managing portion 44.

When an instruction for selecting a thumbnail image displayed on the image display portion 43 is input from the input portion 47, the image data request portion 46 generates an image data transmission request for requesting the recorder 3 as to image data related to the selected thumbnail, based on an instruction from the thumbnail managing portion 44.

The input portion 47 is configured to include a keyboard or a touch panel provided on the image display portion 43, for example, and accepts an input such as a designation of a storage condition for storing a subject to be displayed as a thumbnail into the thumbnail storage portion 45 or a selection instruction for an image displayed as a thumbnail etc.

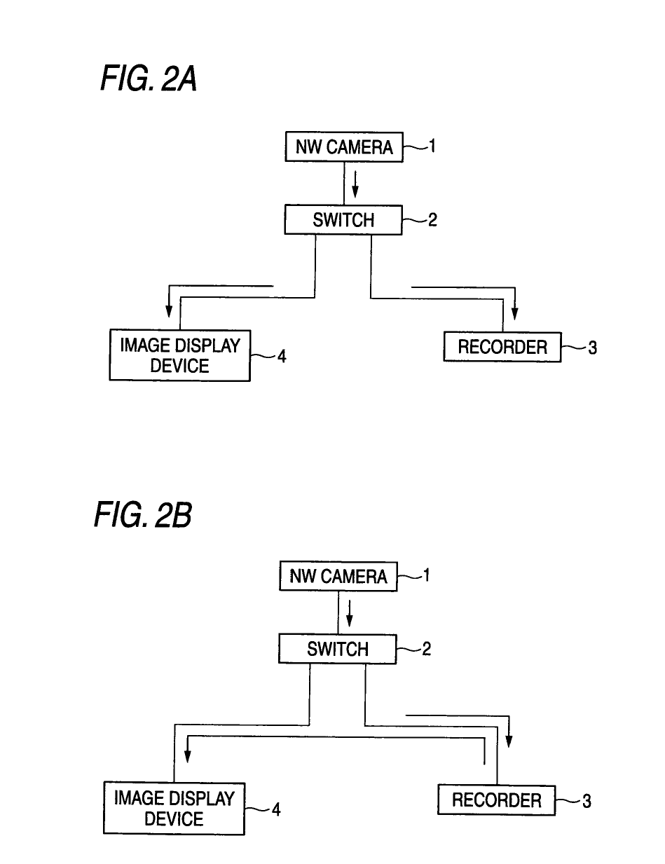

FIG. 2 is an explanatory diagram showing a flow of image data in the image delivering system according to the embodiment of the invention. FIG. 2(A) shows a case where the NW camera 1 performs the multicast delivery, in which image data output from the NW camera 1 is simultaneously delivered to the recorder 3 and the image display device 4 via the switch 2. As another example, the multicast delivery may be performed in a manner that as shown in FIG. 2(B), image data output from the NW camera 1 is delivered to the recorder 3 via the switch 2 and delivered to the image display device 4 from the recorder 3.

Further, the image data may be delivered from the NW camera 1 to the recorder 3 and the image display device 4 via the switch 2 in a unicast manner.

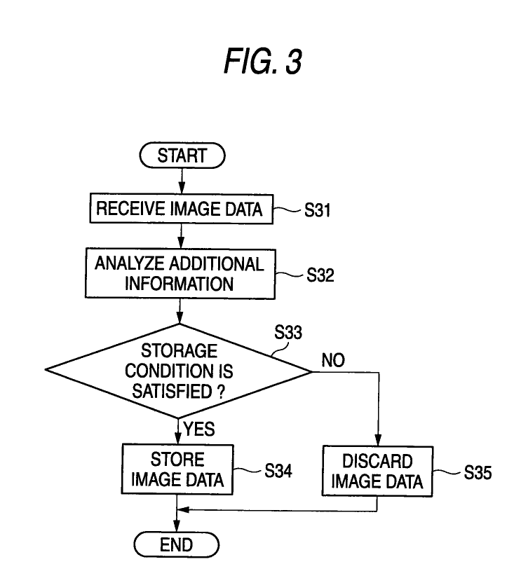

FIG. 3 is a flowchart for explaining a method of storing image data for thumbnails in the image display device according to the embodiment of the invention. As shown in FIG. 3, when the data communication portion 41 receives the coded image data (step S31), the thumbnail managing portion 44 analyzes the additional information superimposed on the coded image data (step S32). In parallel to the operation in the thumbnail managing portion 44, the received image data is decoded by the image display control portion 42 and displayed on the image display portion 43.

The thumbnail managing portion 44 determines whether or not the additional information superimposed on the image data satisfies the predetermined storage condition (step S33). An example of the storage condition is that image data etc. at the head portion (earliest in time) upon the generation of an event is designated.

When the additional information superimposed on the image data satisfies the storage condition (Yes in step S33), the thumbnail managing portion 44 stores the image data as a subject to be displayed as a thumbnail in the thumbnail storage portion 45 (step S34). On the other hand, when the additional information superimposed on the image data does not satisfy the storage condition (No in step S33), the thumbnail managing portion 44 discard the image data (step S35).

The aforesaid storage condition may be a condition for storing image data at a predetermined time point or at every predetermined time other than the condition determined by the additional information.

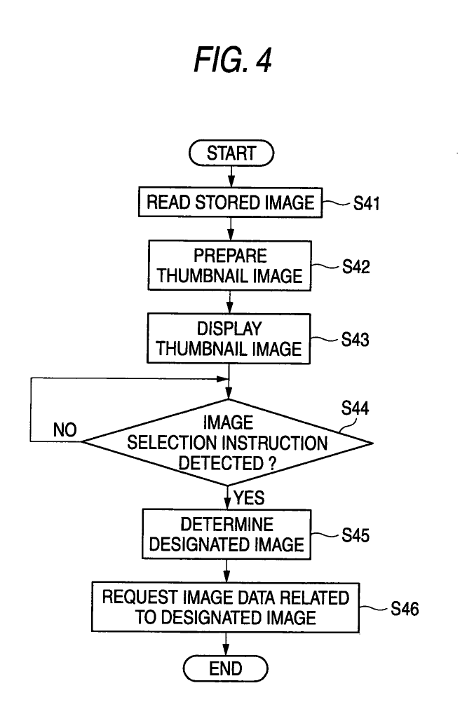

FIG. 4 is a flowchart for explaining the image data retrieving method of the image display device according to the embodiment of the invention. As shown in FIG. 4, when the thumbnail display instruction for retrieving an image is input from the input portion 47, the thumbnail managing portion 44 reads image data from the thumbnail storage portion 45 (step S41). The thumbnail managing portion 44 outputs the image data thus read to the image display control portion 42.

The image display control portion 42 decodes the image data obtained from the thumbnail storage portion 45 to prepare a thumbnail image (step S42). The image display control portion 42 outputs the thumbnail image thus prepared to the image display portion 43, and the image display portion 43 displays this thumbnail image (step S43).

The image display control portion 42 determines whether or not the instruction for selecting a thumbnail image displayed on the image display portion 43 input from the input portion 47 is detected (step S44). When the instruction for selecting a thumbnail image is input from the input portion 47 (Yes in step S44), the image display control portion 42 determines the designated image and notifies it to the thumbnail managing portion 44. The thumbnail managing portion 44 specifies the identification information (time information or additional information) of the image data from the image data corresponding to the image determined by the image display control portion 42 and notifies it to the image data request portion 46 (step S45).

The image data request portion 46 prepares an image transmission request for requesting an image data (for example, in the case where the selected image data is image data at a head portion upon generation of an event, image data etc. of a predetermined time having the image data as a head portion) related to the selected thumbnail image and transmits the request to the recorder 3 via the data communication portion 41 (step S46). The recorder 3 extracts the requested image data from the image data stored therein and transmits the extracted image data to the image display device 4.

In the aforesaid example, the thumbnail storage portion 45 stores the coded image data received from the NW camera 1, and the image display control portion 42 prepares a thumbnail image at the time of displaying a thumbnail on the image display portion 43. Thus, since the thumbnail storage portion 45 stores coded data as to image data as a subject to be displayed as a thumbnail, an amount of data to be stored can be reduced.

Alternatively, the image display control portion may decode image data, which is determined by the thumbnail managing portion 44 to satisfy the storage condition as to a subject to be displayed as a thumbnail, to prepare a thumbnail image and store the thumbnail image thus prepared into the thumbnail storage portion 45. In this case, since the thumbnail storage portion 45 stores thumbnail images thus prepared, at the time of displaying thumbnail images, the thumbnail images prepared in advance are read and displayed on the image display portion 43, whereby thumbnail images can be displayed quickly.

In the image display device 4, even while a user does not watch an image, for example, even when the image display portion 43 does not operate the display portion, the data communication portion 41 continues to receive image data and the thumbnail managing portion 44 operates to determine the storage condition. Thus, image data as a subject to be displayed as a thumbnail can be stored in the thumbnail storage portion 45.

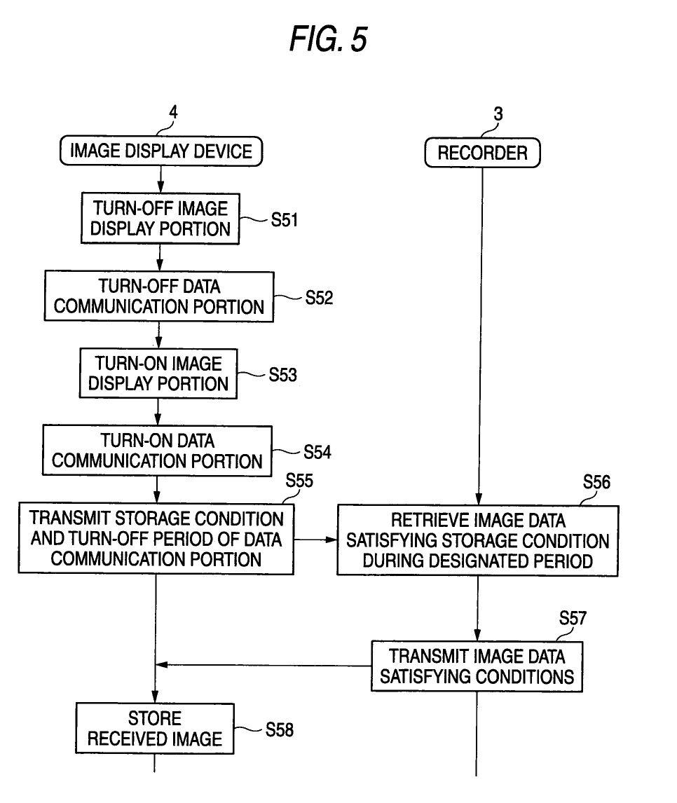

The reception of image data and the determination of the storage condition may be stopped while a user does not watch an image. FIG. 5 is a sequential chart for explaining a method of storing image data for thumbnails in the image display device according to the embodiment of the invention.

As shown in FIG. 5, when the operation of the image display portion 43 is turned off (step S51), the data communication portion 41 turns its communication operation off (step S52). Thereafter, when the image display portion 43 is turned on (step S53), the data communication portion 41 turns its communication operation on (step S54). Then, the thumbnail managing portion 44 instructs, to the image data request portion 46, so as to prepare a request of image data coincident with the storage condition during the turning-off period of the data communication portion 41. Thus, the image data request portion 46 generates the request of image data satisfying both the storage condition and the time condition during the turning-off period of the data communication portion 41 and notifies the request to the recorder 3 via the data communication portion 41 (step S55).

The recorder 3 retrieves image data satisfying the storage condition during the designated time period from the image display device 4 among the stored image data (step S56), and if there is image data satisfying these conditions, transmits the image data to the image display device 4 (step S57). In the image display device 4, the data communication portion 41 receives the image data and the thumbnail managing portion 44 stores the received image data into the thumbnail storage portion 45 (step S58).

In this manner, since the reception operation of image data is stopped while the image display portion 43 does not operate, an amount of dissipation power can be reduced. Further, since the image data as a subject to be displayed as thumbnails is requested to the recorder 3 after the restart of the operation of the image display portion 43, image data to be stored can be secured.

According to the embodiment of the invention thus configured, since the image display device 4 stores only image data which is a subject to be displayed as thumbnails, it is possible to eliminate a procedure of obtaining thumbnail image data for retrieval from the recorder 3 side at the time of the image retrieval and so a time period required for the retrieval can be shortened. Further, an amount of data communicated between the recorder 3 and the image display device can be suppressed. For example, in a system of delivering images from a so-called cameral 1 such as a surveillance camera, at the time of retrieving images having been picked-up in the past, the retrieval utilizing thumbnail images can be performed on the image display device 4 side.

Further, since it is not necessary to prepare thumbnail images at the recorder 3, the recorder 3 is not required to have a decoder therein and so the configuration of the recorder 3 can be simplified.

Although the invention has been explained in detail with reference to the particular embodiment, it will be clear for those skilled in the art the various changes and modifications may be made without departing from the spirit and scope of the invention.

The present application is based on Japanese Patent Application (Japanese Patent Application No. 2006-116791) filed on Apr. 20, 2006, the content of which is incorporated herein by reference.

### INDUSTRIAL APPLICABILITY

The image display device and the control method thereof according to the invention has the effects that the image retrieving time can be shortened and the amount of data to be transmitted for retrieval can be suppressed, and are useful for a network camera system etc.

1. An image display device which is connected via a communication line to an image delivery device for delivering images and an image storage device for storing the delivered images and displays the delivered images on a display portion, the image display device comprising:
a data communication portion which receives image data from the image delivery device;
an image display control portion which decodes the image data received by the data communication portion and subjects the decoded data to an image processing to output to the image display portion;
a reduced image managing portion which determines whether or not the image data received by the data communication portion satisfies a predetermined condition as a subject to be displayed as a reduced image; and
an image data storage portion which stores only image data that is determined to satisfy the condition by the reduced image managing portion.

2. The image display device according to claim 1, wherein
when an instruction of displaying a reduced image is input, the reduced image managing portion reads image data from the image data storage portion and outputs the image data thus read to the image display control portion, and
the image display control portion decodes the image date obtained from the reduced image managing portion to prepare the reduced image.

3. The image display device according to claim 1, wherein
the image display control portion decodes image data which is determined to satisfy the condition as the subject to be displayed as the reduced image by the reduced image managing portion to prepare the reduced image and stores the reduced image in the image data storage portion.

4. The image display device according to claim 1 further comprising:
an image data request portion which requests, when an instruction of selecting the reduced image displayed on the display portion is input, the image storage device as to image data relating to the selected reduced image.

5. The image display device according to claim 4, wherein
the data communication portion stops reception of the image data while the display portion is not operated, and
the image data request portion requests, when an operation of the display portion is restarted, the image storage portion as to image data satisfying the condition as the subject to be displayed as the reduced image.

6. An image delivering system comprising:
the image display device according to claim 1;
an image delivering device which is connected to the image display device via a communication line and delivers image data; and
an image storage device which stores images delivered from the image delivering device.

7. The image delivering system according to claim 6, wherein the image delivering device is a camera device which has an image pickup portion for picking up an image and delivers picked-up image data to the image display device and the image storage device.

8. A method of controlling an image display device which is connected via a communication line to an image delivery device for delivering images and an image storage device for storing the delivered images and displays the delivered images on a display portion, the method comprising:
receiving image data from the image delivery device;
decoding the received image data and subjecting the decoded data to an image processing to output to the image display portion;
determining whether or not the received image data satisfies a predetermined condition as a subject to be displayed as a reduced image; and
storing only image data that is determined to satisfy the condition into an image storage portion.

9. A computer readable recording medium storing a program which causes a computer for executing to execute the respective steps of claim 8.
